(19) United States
(12) Patent Application Publication
(10) Pub. No.: US 2004/0219368 A1
(43) Pub. Date: Nov. 4, 2004

(54) Glazing in particular for motor vehicle roof panel

(76) Inventors: Dominique Coster, Temploux (BE); Denis Legrand, Wargnies (FR)

Correspondence Address: Supervisor Patent Prosecution Services, PIPER RUDNICK LLP, 1200 Nineteenth Street, N.W., Washington, DC, 20036-2412, US

(21) Appl. No.: 10/639,642

(22) Filed: Aug. 13, 2003

Related U.S. Application Data
(63) Continuation of application No. 10/019,564, filed on Jan. 25, 2002, now abandoned.

(30) Foreign Application Priority Data
Jun. 30, 1999 (BE) BE9900452
Jun. 21, 2000 (WO) PCT/EP00/05696

(51) Int. Cl. B32B 15/00; B32B 17/06

(52) U.S. Cl. 428/432

(57) ABSTRACT

Disclosed are laminated glazings with low light transmission for use in motor vehicles. The glazings include at least two glass sheets assembled by means of a thermoplastic interlayer sheet, which have a light transmission (TL) less than 35%, an energy transmission less than 15%, and calorimetric characteristics such that on the CIE chromaticity diagram it is included within the perimeter defined by the co-ordinate points: B(0.2600; 0.3450); F(0.3300; 0.3300); G(0.3150; 0.2900); H(0.2350; 0.2750).

The present invention relates to glazing used for motor vehicles, and in particular to glazing for forming part of roofs or other parts of the motor vehicle which only require a limited light transmission such as side or back glazing units. For convenience, the following description refers to roof panels, but this includes all glazing likely to meet the same conditions of use.

The glazing units used in motor vehicle roofs have firstly been used in the formation of opening panels. These elements were of small dimension. The mechanical requirements for these panels were restricted to their respective resistance. These first panels were made from monolithic glass sheets which satisfactorily met these not very restrictive requirements. The glasses used for the formation of such panels are described in FR-A 2 738 238, for example.

Furthermore, it became immediately apparent that the heat admission associated with the presence of these glazed panels located on the roof of motor vehicles had to be controlled. Various solutions have been proposed to minimise this admission, in particular the use of coloured glasses, use of glasses bearing thin absorbent or reflective layers, or also of glass sheets having a light transmission which is restricted by the presence of an enamelled pattern which partially screens the transparent surface.

The design engineers systematically strive for an increase in the transparent surfaces and now undertake to equip vehicles with glazing units which cover a significant part, if not the whole of the roof. Replacement of the traditional metal roof by glazing poses various problems which go beyond those encountered previously with the panels of small dimension.

The question of protection against heating of the passenger compartment is of course all the more critical as the area concerned is more important. An extension of the surface area of up to ten times that of previous panels requires very efficient solutions in energy control. The formation of these roofs, however, also poses specific problems. Firstly, the types of glazing used must provide mechanical properties which are at least equal to those of traditional metal roofs, in particular those contributing to the rigidity of the overall structure. Roof glazing should also provide all the passenger safety guarantees in the case of an accident, like other types of glazing, in particular windscreens. Therefore, they must not pose any risk of laceration when fractured. They must also provide a barrier to prevent passengers from being thrown out of the vehicle. Finally, they must meet the requirements concerning optical characteristics in the interests of passenger comfort, in particular by restricting the energy entering the passenger compartment, as indicated above, but also by restricting the luminosity in order to maintain the “private” character of the passenger compartment. Manufacturers must still be able to produce them at acceptable cost. In addition to all these requirements there are others which relate to more subjective considerations such as those concerning the aesthetics of the interior and exterior of the vehicle. In particular, the transmitted light must not be “coloured” in a way which would change the perception of objects and persons present in the passenger compartment in a displeasing manner. A light which is satisfactory from this viewpoint is classed as “neutral”. In a simplified manner, this corresponds to the types of glazing which are perceived as essentially “grey” on transmission. However, if need be, some colours are accepted and even desired by manufacturers so long as they do not produce a disturbing “colour rendition”. In practice, manufacturers are currently able to accept blue and blue-green tints, for example.

The monolithic glazed panels placed on roofs originally had a thickness of 4 to 7 mm. These thicknesses were adequate for these elements in a structural role. For safety reasons, the panels in question underwent a thermal toughening process. Subsequently, laminated assemblies were also proposed with the aim of providing well known safety characteristics, in particular, like those of the types of glazing forming windscreens.

The use of laminated panels in the roofs of motor vehicles was proposed in particular to introduce thin functional layers. The laminated structure has the advantage of combining the presence of these layers with a favourable resistance to wear stresses. The functional layers located on the faces of the glazing not in contact with the surroundings are shielded from damages resulting from cracking, abrasion etc., which is contrary to what can result by using a layer located on a monolithic glazing unit.

An aim of the invention is to propose glazing units intended to form a substantial part, or even the whole of the roof area of motor vehicles, or glazing units which should have similar characteristics and which provide advantageous solutions in response to the different requirements outlined above.

The glazing units according to the invention are composed of at least two glass sheets assembled by means of an interlayer sheet made of a thermoplastic material traditionally used in laminated glazing units, said glazing having an energy transmission, ET, of less than 15%, a light transmission, LT, which is not more than 35%, and the transmission characteristics thereof resulting in a light with characteristics included on the CIE chromaticity diagram within the perimeter defined by the coordinate points: B(0.2600; 0.3450); F(0.3300; 0.3300); G(0.3150; 0.2900); H(0.2350; 0.2750).

The energy transmission, ET, of the glazing according to the invention is as low as possible. It is desirable in all cases to restrict the energy admission so as to prevent heating of the passenger compartment, and/or not to needlessly resort to the installation of air-conditioning which is a heavy consumer of energy. According to the invention, the energy transmission is preferably 10% at most of the incident energy. Advantageously, this transmission is less than 8%, or even 6%.

As indicated above, the aim is to reduce the energy transmission to values less than 10%. It is possible according to the invention to use some laminated glazing units which have the chromatic features indicated above and which allow a little more than 10% of the incident energy to pass through. However, in these conditions, the glazing in question is preferably distinguished by characteristics relating to the iron content. These types of laminated glazing comprise at least two sheets of glass, wherein the chromophore agents contain iron with a total iron content expressed in Fe₂O₃ in the range of between 0.9 and 1.8%. The two glass sheets must both meet this condition at the same time, but may otherwise have identical or different compositions. While these particular conditions are less demanding with respect to restriction of the energy transmission, they do not allow the necessity of controlling this energy transmission to be disregarded. The latter must not exceed 15%. Glazing of this type may be used in particular when the dimensions thereof are not too large and when the energy question is less critical.

The usual means for restricting the energy transmission: colouring of glasses, provision of reflective or absorbent layers, partial enamelling of the glazing, at the same time result in a reduction of the visible light transmission. In practice, almost half the solar energy is transmitted by radiation in the visible range. It is thus understood that the objective is also to reduce transmission in the visible, if only to reduce the energy transmission accordingly. The reduction in light transmission is still desired by manufacturers to benefit the private nature of the passenger compartment. A light transmission of less than 35% is the highest which will allow this requirement of reduced luminosity, which conceals the interior of the passenger compartment from the observer on the outside, to be met and appreciably lower the corresponding energy admission. The light transmission is preferably no greater than 25% and, particularly preferred, no greater than 20%.

Similarly, the reduction in visible light transmission must preferably not be perceived as excessive by passengers. A minimum transmission must be maintained to retain the impression of a “transparent roof”. Nevertheless, this impression may be retained with very low light transmissions, e.g. in the order of 5% or less. Glazing according to the invention mostly has an LT which is not less than 10%.

The chromaticity elements referred to in the definition of the invention are explained again below to provide more clarity, although specialists in the field of coloured glasses are conversant with them.

As a general rule, the optical properties of a glass sheet are related to a standard illuminant. Those most usually used are illuminant C and illuminant A as defined by the Commission Internationale de l'Éclairage (CIE) [International Commission of Illumination]. Illuminant C represents the light of an average day with a colour temperature of 6700 K. Above all, this illuminant is useful for evaluation of the optical properties of types of glazing destined for the building industry. Illuminant A represents the radiation of a Planck radiator at a temperature of about 2856 K. This illuminant represents the light emitted by the headlights of a motor vehicle and is essentially intended for evaluation of the optical properties of types of glazing used for motor vehicles. The Commission Internationale de l'Éclairage has also published a document entitled “Colorimétrie, Recommandations Officielles de la C.I.E.” [Colorimetry, Official Recommendations of the CIE] (May 1970), which describes a system in which the calorimetric coordinates for light of every wavelength of the visible spectrum are defined such that they may be represented on a diagram having orthogonal axes x and y, referred to as a trichromatic diagram, CIE 1931. This trichromatic diagram shows the representative position of light of each wavelength (expressed in nanometres) of the visible spectrum. This position is called the “spectrum locus” and the light whose coordinates are located on this spectrum locus is said to possess 1000% purity of light stimulus for the appropriate wavelength. The spectrum locus is closed off by a line called the purple boundary which joins the points of the spectrum locus whose coordinates correspond to wavelengths 380 nm (violet) and 780 nm (red). The area contained between the spectrum locus and the purple boundary is that available for the trichromatic coordinates of all visible light. The coordinates of the light emitted by illuminant C, for example, correspond to x=0.3101 and y=0.3162. This point C is considered to be representative of white light and therefore has a purity of light stimulus equal to zero for every wavelength. Lines may be drawn from point C to the spectrum locus at every desired wavelength, and each point located on these lines may be defined not only by its coordinates x and y, but also as a function of the wavelength corresponding to the line on which it is located, and of its distance from point C in relation to the total length of the wavelength line. Consequently, the hue of the light transmitted by a coloured glass sheet may be described by its dominant wavelength and its purity of light stimulus expressed as a percentage.

The CIE coordinates of light transmitted by coloured glazing is dependent not only upon the composition of the glass but also on its thickness.

The following are used once again in the description below as well as in the claims:

the total light transmission for illuminant A (LTA) measured for a thickness of 4 mm (LTA4) and a solid angle of observation of 20. This total transmission is the result of integration between the wavelengths of 380 and 780 nm of the term: ΣT_{λ}.E_{λ}.S_{λ}/ΣE_{λ}.S_{λ}, wherein T_{λ} is the transmission at wavelength λ, E_{λ} is the spectral distribution of illuminant A and S_{λ} is the sensitivity of the normal human eye as a function of wavelength λ.

the total energy transmission (ET) according to Moon (ISO 9050) measured for a thickness of 4 mm (ET4) and at a solid angle of observation of 20. This total transmission is the result of integration between the wavelengths of 300 and 2500 nm of the term: ΣT_{λ}.E_{λ}/ΣE_{λ}, wherein E_{λ} is the spectral energy distribution of the sun at 30° above the horizon.

the selectivity (SE) measured by the relation of the total light transmission for illuminant A and the total energy transmission (LTA/ET).

total transmission in the ultraviolet range measured for a thickness of 4 mm (TUV4). This total transmission is the result of integration between 280 and 380 nm of the term ΣT_{λ}.U_{λ}/ΣU_{λ}, wherein U_{λ} is the spectral distribution of the ultraviolet radiation having crossed the atmosphere determined in the standard DIN 67507.

the colour (λ, P, x, y) is calculated in illuminant C, with solid angle of observation 2°, for the considered thickness of the glazing.

the colour rendition index is determined according to the standard EN 410 (illuminant D₆₅).

The coordinates of the colorimetric perimeter corresponding to the features of the invention generally result in glazing types with an appearance in transmission which is grey or bluish in the section of this colorimetric perimeter corresponding to the lowest coordinates, in other words: for the section closest to point H. The degree of purity retained for glazing corresponding to this section means that the colour rendition remains satisfactory.

The bluish hue is included in the scope of the invention to meet the desire to harmonise all the glazing units of the same motor vehicle, where necessary. In recent times, the manufacturers' choice for side and back glazing has tended towards bluish colorations with degrees of purity varying according to the type of glazing considered, the most strongly coloured being usually located at the rear of the vehicles.

The choice according to the invention is preferably for the most neutral products. On this basis, an advantageous perimeter is defined by coordinate points B′(0.2650; 0.3350); F′(0.3200; 0.3200); G′(0.3100; 0.3000); H′(0.2500; 0.2900). Particularly preferred, the glazing according to the invention has a light transmission with characteristics corresponding to the perimeter of B″(0.2800; 0.3300); F″(0.3089; 0.3225); G″(0.2890; 0.2975); H″(0.2600; 0.2930).

The glazing according to the invention may constitute a more of less significant part of the area of the roof of motor vehicles for which they are intended. They may also be used to form other glazed elements of the vehicle, as indicated above. As a general rule, the area of these glazing units is relatively significant compared to the panels of previous roofs—in the order of a square metre—and for large vehicles of the “people carrier” type, this area may be increased to two square metres or more. The glazing types according to the invention, which meet the specific requirements of large dimensions, may naturally also be used advantageously to form elements of smaller dimension and in particular for roof panels.

The laminated structure traditionally comprises two glass sheets assembled by means of a thermoplastic interlayer sheet. It is possible to assemble more than two glass sheets. However, in practice such a solution, which could lead in particular to further improved mechanical properties, encounters problems of weight and cost. A plurality of sheets, even if the thickness of each is limited, can only result in an increase in total thickness. Moreover, a more complex structure obviously adds to the production cost. For these reasons, as a general rule, the glazing types according to the invention are normally formed from two glass sheets and one thermoplastic interlayer sheet.

The glazing units are assembled in a traditional manner. The materials forming the basis for the interlayer sheet are, in particular, polyvinyl butyral (PVB), polyvinyl acetate (PVA), polyvinyl chloride (PVC), and polyurethane resins (PU). These interlayer materials may be chosen, if need be, to contribute to the provision of optical properties of the glazing. For information purposes, the PVB sheets traditionally include uv-screening agents, whose role is to protect the material against aging, but at the same time provide the glazing with stronger filtering properties for uv rays. The thermoplastic sheets can also play a part in providing the required conditions with respect to light transmission or even with respect to colour. With respect to the latter, it is possible to use interlayer sheets which are themselves coloured in their foundation.

The nature of the colouring agents used for thermoplastic materials, and thus the properties thereof, differ appreciably from those of glass colouring agents. The most important difference for application according to the invention relates to the energy transmission. It is known that iron oxides play a part in the base of glass colourings. In particular, the adjustment of the ferric oxide/ferrous oxide contents makes a very significant contribution not only to establishing the colour but also to establishing the energy transmission. The colouring agents usually used in plastic sheets absorb proportionally much more in the visible than in the infrared range. With the knowledge that, for a given light transmission, the general aim is to have the lowest possible energy transmission, the selection of a coloured interlayer is not generally preferred. Nonetheless, the use of coloured interlayer sheets is not excluded. They are used to complete, adjust or correct the coloration given to the glazing by the glass sheets, and possibly by thin additional layers.

For information purposes, when a glazing is required which has characteristics placing it in the blue zone in the chromaticity diagram, it is possible—working from a glass sheet with green coloration by association with a blue interlayer—to give the formed assembly a predominantly blue coloration.

We have indicated above what conditions the glazing according to the invention has to meet. We have also outlined the main characteristics of the sheets. The selection of the glass sheets is of course decisive for the properties of the glazing. For this reason, in the aim of obtaining a “neutral” or “bluish” glazing with a low energy transmission and a controlled light transmission, glass sheets which already have these types of properties individually are preferably used. In other words, it is advantageous to use glass sheets, which have a very low light stimulus purity and have restricted energy and light transmissions, or assemblies comprising a sheet of this type.

Hence, it is advantageous to use at least one grey glass sheet, the light stimulus purity of which is less than 10%, and which, with a thickness of 4 mm, has a light transmission (LT) of less than 25% and preferably less than 20%. Glasses corresponding to these conditions are, for example, soda-lime glasses with traditional structural components in the following contents by weight:

| | | | |
|---|---|---|---|
| SiO₂ | 60-75% | Al₂O₃ | 0-5% |
| Na₂O | 10-20% | BaO | 0-2% |
| CaO | 0-16% | BaO + CaO + MgO | 10-20% |
| K₂O | 0-10% | K₂O + Na₂O | 10-20% |
| MgO | 0-10% | | |

Chromophore constituents are added to these components, i.e. Fe₂O₃, Co, Se, Cr₂O₃. “Grey” glasses of this type are those in particular containing chromophore agents in the following amounts:

| | |
|---|---|
| Fe₂O₃ | 1-1.65% |
| Co | 0.017-0.030% |
| Se | 0.001-0.0100% |

Another advantageous combination of chromophores additionally comprises chromium oxide. In this case the preferred amounts are, for example:

| | |
|---|---|
| Fe₂O₃ | 0.75-1.8% |
| Co | 0.0040-0.0180% |
| Se | 0.0003-0.0040% |
| Cr₂O₃ | 0.0010-0.0100% |

Glasses of these types are described in detail in particular in publications FR-A 2 738 238 and 2 738 240.

All the above glasses are very neutral and “grey” on transmission. As indicated above, the glazing according to the invention may have a bluish hue, if required. To form this type of glazing, it is advantageous to include at least one glass sheet with this type of coloration in the assembly.

One glass of this preferred type is a soda-lime glass, for example, the chromophore constituents of which are essentially iron oxides and cobalt in the following proportions by weight:

| | |
|---|---|
| Fe₂O₃ (total iron) | 1.1-1.8% |
| FeO | 0.30-0.50% |
| Co | 0.0030-0.0270% |

and other agents are possibly added to these in the ranges indicated below:

| | |
|---|---|
| Cr₂O₃ | 0-0.1000% |
| V₂O₅ | 0-0.0500% |
| CeO₂ | 0-0.5% |
| TiO₂ | 0-1.5% |
| Se | 0-0.0100% |

Blue glasses meeting this definition are described in detail in the European patent application filed on 22 Dec. 1998 under the number 98 124 371.0.

If a blue glass sheet such as that indicated above is used, its transmission characteristics, in conjunction with 4 mm, are usually in the order of an LT of 35 to 45% and an ET of 20 to 30%. A sheet of this type with a thickness of 2 mm, for example, should be combined with a more absorbent neutral glass sheet to form a glazing which meets the characteristics of the invention. For example, combination with a highly absorbent grey sheet of the type of those described above results in a satisfactory assembly. Examples of such combinations are given below in more detail.

It is also advantageous according to the invention to use at least one glass sheet known for its low energy transmission. Glasses of this type with high selectivity are those with chromophores in the following proportions:

| | |
|---|---|
| Fe₂O₃ (total iron) | 1.2-1.85% |
| FeO | 0.40-0.50% |
| Co | 0.0020-0.013% |
| Cr₂O₃ | 0-0.0240% |
| V₂O₅ | 0-0.1% |
| Se | 0-0.0015% |

These glasses have a very deep colour with a green to blue hue. Their selectivity often exceeds 1.65. They are described in detail in the French patent application filed on 31 Jul. 1998 under the number 98/100020.

Another series of highly selective coloured glasses with low energy transmission corresponds to the compositions in which the chromophores are either:

| | |
|---|---|
| Fe₂O₃ (total iron) | 1.2-1.8% |
| FeO | 0.25-0.35% |
| Co | 0.0020-0.010% |
| Cr₂O₃ | 0.001-0.0100% |
| CeO₂ | 0.1-0.8% |

| | |
|---|---|
| Fe₂O₃ (total iron) | 0.9-1.8% |
| FeO | 0.25-0.35% |
| Co | 0.0010-0.010% |
| Cr₂O₃ | 0-0.0240% |
| V₂O₅ | 0-0.2% |

These highly coloured glasses are also grey-green. They have a selectivity which is normally greater than 1.5. They are described in the publication EP-A 0887320.

The characteristics of at least one of the preferred glass sheets individually meet the following conditions:

P<20%

R>−P+80%

wherein P is the light stimulus purity measured with 4 mm thickness with illuminant C at a solid angle of observation of 2°, and R is the colour rendition index as defined in the standard EN 410. The latter index indicates observation through a determined glazing of an assembly of eight colour samples illuminated by the reference illuminant D₆₅. The colour rendition index is all the higher because the presence of the glazing modifies at least the perception of the colours. The grey glasses in the assembly are those where the colour rendition index is the highest. It is generally higher than 80% and can reach and even exceed 90%. Comparatively, the glasses which provide a bluish hue have a lower index overall which lies at about 75%. As a general rule, sheets which have a colour rendition index which is not less than 70 and preferably 75% are used to form glazing units according to the invention.

The most neutral glasses and which are grey in colour advantageously correspond to the following conditions:

P<10%

R>−P+90%

As above, the important factor is of course what the complete glazing allows to be achieved. According to the invention, the glazing advantageously has a colour rendition index higher than 70% and preferably higher than 75%.

The selection of the glasses of the sheets forming the glazing according to the invention is still dependent on the thickness retained. In this regard, it must be remembered that if the thickness of the glass sheets has an obvious effect on the optical characteristics, and in particular on the light and energy transmission values, selection of the thicknesses cannot be made without considering the constraints of weight. However, without being imperative, these cause types of glazing to be preferred which meet the requirements indicated above and which are, moreover, the lightest possible. The ideal would be to have roofs with a mass which would not be greater than that of roofs of corresponding sheet metal. Irrespective, the manufacturers wish to limit the additional cost incurred by using a glazing unit.

In practice it is desirable not to exceed a thickness in the order of 6.5 mm and preferably 5.5 mm. Despite the advantage associated with glazing types with a low thickness, and therefore of limited weight, it is difficult to produce glazing which has a thickness of less than 4 mm and retains all the properties, in particular mechanical resistance, required of glazing used in the conditions of the invention.

In these conditions, the glass sheets used to form the laminated glazing advantageously have a thickness of at least 1.8 mm and at most equal to 4 mm. The thickness of each of the glass sheets is preferably in the range of between 2 and 3.8 mm.

The weight of the interlayer sheet in the glazing is relatively low in relation to that of the glass sheets. For this reason, the selection of the thickness is essentially ruled by considerations relating to the conditions of production and to the mechanical properties of the glazing formed. A very low thickness can complicate the assembly of the glass sheets and/or weaken the glazing. In practice, the interlayer sheet has a thickness at least equal to 0.3 mm. Conversely, an additional increase beyond a certain thickness does not improve the mechanical properties and increases cost. For this reason, an interlayer is preferably used which has a thickness which is not greater than 1.5 mm and more advantageously is less than 1 mm.

Traditionally, the glazed panels used previously were toughened to meet safety requirements. The fact that the types of glazing according to the invention are laminated is of benefit to the inherent properties of this type of structure. In the case of impact, in particular, the sheets can fracture but the pieces of glass are held by their adherence to the interlayer sheet, thus preventing risks of laceration. In the same way, the retention of the structure of the glazing after the glass sheets have fractured reducing the risk of passengers being thrown out in the case of an accident.

However, the qualities of the laminated glazing do not allow some capabilities of the toughened glazing to be reached with respect to mechanical resistance. For information purposes, for the same glass thicknesses, the bending resistance of an enclosed toughened sheet is 50 (instantaneous, 10 s) and 20 MPa (permanent) respectively for the toughened sheet and only 20 and 10 MPa for the corresponding laminate.

In practice, it is proposed according to the invention in order to find characteristics close to those of toughened glasses, in particular with respect to bending resistance, to use semi-toughened glasses which are well suited to forming laminates and have improved mechanical properties in relation to these. The bending resistance values for characteristics analogous to previous ones are thus established at respective values which are at least two-thirds of those of toughened glasses. Typically, for the previous conditions, the semi-toughened (or hardened) glass has bending resistance values (instantaneous and permanent) in the order to 35 and 15 MPa.

The glazing according to the invention may also include functional layers. These are normally sunshield layers whose main role is to further reduce the energy transmission inside the passenger compartment. These are traditional absorbent and/or reflective layers. In particular, these are layers based on conductor oxides such as tin oxides, doped or not, in particular with fluorine or antimony, layers based on tin or indium oxide or metallic layers such as single or multiple layers of silver.

When such layers are present, they are placed preferably on the faces of the glazing which are not exposed to the ambient air after assembly. These are the faces in contact with the thermoplastic interlayer sheet. In this position, the thin layers are protected from accidental radiation damage or similar.

The sunshield layers usable according to the invention may be produced using the usual techniques in this field, i.e. principally pyrolysis techniques or vacuum deposition techniques. The pyrolysis techniques are the ones which result in less expensive layers. They may be conducted directly on the ribbon of glass during formation.

The most usual method is to proceed with a technique of gas pyrolysis (CVD) in the chamber of the “float” or at the outlet thereof to benefit from the temperature of the ribbon of glass to perform the pyrolysis. However, conducting pyrolysis in these conditions can pose a problem when processing a glass sheet with low thickness. The fact that the reaction is produced from the stored energy implies a modification in the thermal state of the sheet that is much more critical as this is thinner. On very thin sheets, of 2 mm or less, the lowering of the temperature of the treated face can cause deformations of the sheet which are detrimental to a well controlled treatment. In the case where a pyrolytic layer must be included in the glazing, it is advantageous to choose to apply it onto the thickest sheet, but this does not exclude other solutions.

Vacuum deposition processes are not associated with these difficulties, but are performed discontinuously, sheet by sheet, and their cost is appreciably higher. For this reason, wherever possible the glazing according to the invention is preferably formed without layers other than those which can be formed continuously on the glass of the sheets.

It is self-evident that each of the sheets is able to receive one or more identical or different layers. It is possible, in particular, to deposit a pyrolytic layer of tin oxide, for example, on the thickest sheet, and an assembly of silver-based layers by vacuum deposition on the other sheet.

The invention is described in more detail in the examples and with reference to the attached figures where necessary, wherein:

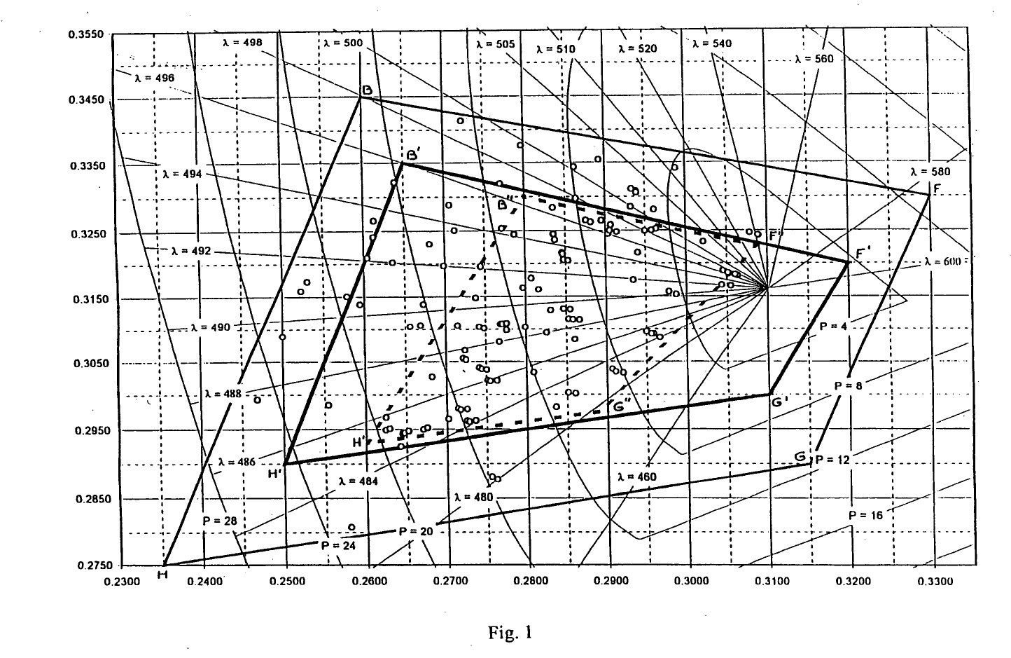

FIG. 1 is a section of the CIE chromatic diagram;

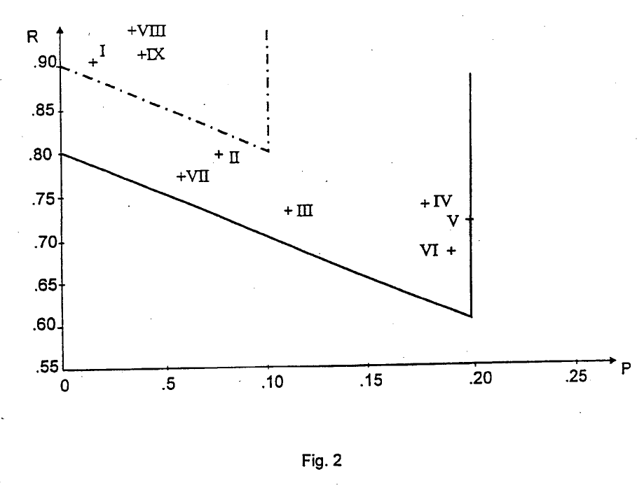

FIG. 2 is a graph of the relationship between the colour rendition index and the light stimulus purity, indicating the preferred areas according to the invention;

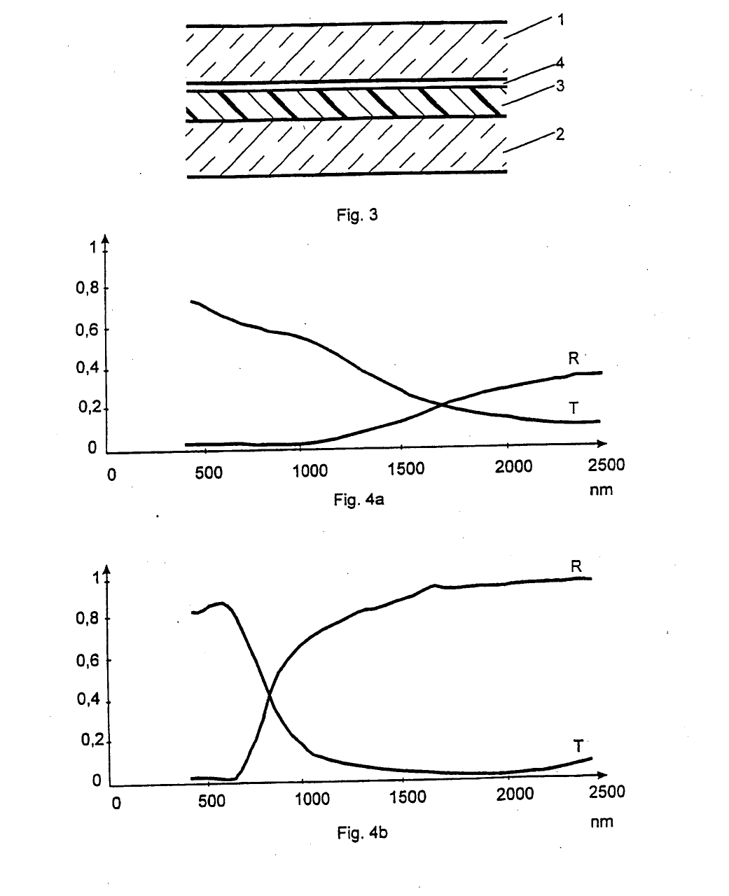

FIG. 3 is a schematic representation of a section of glazing according to the invention;

FIGS. 4a and 4b are transmission/reflection diagrams produced by typical thin sunshield layers.

Different glasses have been used for the practical examples of the glazing types according to the invention. All these glasses have practically identical compositions based on soda-lime and correspond to the following weight proportions:

| | |
|---|---|
| SiO₂ | 71-72.5% |
| Al₂O₃ | 0.13-0.95% |
| Na₂O | 13.7-13.75% |
| CaO | 8.3-8.7% |
| K₂O | 0.05-0.16% |
| MgO | 3.7-4.1% |

The chromophore constituents of the different glasses are specified in the following table. The most important optical characteristics for the object of the invention are also indicated in this table. These concern the light transmission, LT, energy transmission, ET, light stimulus purity P, and the colour rendition index R. The measurements of the optical properties, except for P, are given for the reference thickness of 4 mm. The purity is determined for a thickness of 5 mm on specific internal transmission.

The iron content is the total iron content expressed as Fe₂O₃ in the traditional manner.

| | GLASS | | | | | | | | |
|---|---|---|---|---|---|---|---|---|---|
| | I | II | III | IV | V | VI | VII | VIII | IX |
| Fe₂O₃ % | 1.243 | 1.324 | 1.555 | 1.29 | 1.461 | 1.63 | 1.65 | 0.837 | 0.95 |
| Fe²⁺/ | 0.2662 | 0.3005 | 0.3145 | 0.333 | 0.356 | 0.332 | 0.27 | 0.2683 | 0.30 |
| total Fe | | | | | | | | | |
| SO₃ % | 0.15 | 0.14 | 0.14 | 0.13 | 0.14 | 0.18 | 0.2 | 0.2 | 0.16 |
| TiO₂ % | 0.031 | 0.050 | 0.048 | | | | | 0.05 | |
| Co(ppm) | 177 | 43 | 80 | 70 | 68 | 94 | 235 | | 7 |
| Se(ppm) | 37 | | | | | | 37 | | |
| Cr₂O₃ | | 133 | 214 | | | 203 | | | |
| (ppm) | | | | | | | | | |
| V₂O₅ | | 238 | 429 | | | 503 | | | 150 |
| (ppm) | | | | | | | | | |
| LTA4 | 16.9 | 45.3 | 32.2 | 40.7 | 35.9 | 27.3 | 10 | 71.1 | 66 |
| ET4 | 15.38 | 25.24 | 17.51 | 23.2 | 19.4 | 14.8 | 8 | 44.7 | 39 |
| P | 1.8 | 9.4 | 13.5 | 19.8 | 20.3 | 18.8 | 5.8 | 3.61 | 4.5 |
| R | 90.2 | 79.2 | 72.5 | 75 | 72 | 68 | 79.5 | 95 | 92 |

FIG. 2 shows the position of these glasses on the purity/colour rendition index diagram. The grey glass of example I is that which at the same time has the lowest purity and the highest colour rendition index. This glass is in the particularly preferred field defined by the conditions P and R. The other glasses prepared in these examples are in the broader field also defined on the basis of relations between P and R. This corresponds favourably to glasses which generally have properties of interest with respect to energy and light transmission, but their transmitted light is not entirely neutral and which therefore introduce modifications in the restitution of the colours. Nevertheless, these glasses are useful in the formation of the types of glazing according to the invention, particularly when they are combined with a neutral glass such as that which appears in the examples given in the following description.

Various types of laminated glazing have been produced from these glasses made in several thicknesses. In all these types of glazing the interlayer sheet is a colourless PVB sheet with a thickness of 0.76 mm, with the exception of examples 137, 138, 164, 166 and 177, in which the interlayer sheet is blue in colour. In examples 173, 174 and 176, the interlayer is formed from an assembly composed of PVB combined with a PET sheet on which a stack based on silver layers is deposited. This type of interlayer is of interest to supply products which are well suited to cambering operations. The functional layers deposited on the PET are less sensitive to the possible degradations resulting from these cambering treatments than those deposited directly on a glass sheet. In the table the presence of this particular interlayer is recorded in the column relating to the layers by marking with S.

In addition, in its role as adhesive of the two glass sheets, the PVB forms a very powerful filter for ultraviolet rays. The uv transmission of the PVB sheet used is less than 1%.

The different types of glazing produced and their properties are collated in the following table in which appears:

the nature of the glass of each sheet;

the thickness of each sheet e₁, e₂ in mm;

the total thickness of the glazing formed eᵥ;

indication of the functional layers present;

the light transmission of the glazing;

the energy transmission of the glazing;

the light stimulus purity of the glazing;

the colour rendition index of the glazing;

the dominant wavelength on transmission, λ_{D}, in nm.

The functional layers outside of those inserted with the interlayer are systematically placed on the face of the glass turned towards the PVB interlayer. The layers tested are, on the one hand, layers of tin oxide doped with antimony (C₁ and C₂) of the type described in the patent publications BE-A 1010321 and 1010322, and, on the other hand, layers of silver (C₃) such as those described in the patent publication EP-B 336257.

Layers C₁ and C₃ respectively have transmission and reflection spectrums which form the subject of FIGS. 4a and 4b. As indicated, these are sunshield layers. It is evident for layer C₁ that the infrared transmission (from 800 to 2500 nm) is appreciably reduced. The reason for this reduction is the infrared reflection for one part which increases with the wavelength. The infrared reflection is practically zero for the visible wavelengths (less than 800 nm). The characteristics of C₂ are not shown. They are analogous to those of C₁ with a still further limited transmission. The diagram 4b corresponding to a silver-based layer assembly (two layers of silver separated by a layer based on tin oxide) shows a transmission even further reduced than previously in the infrared range. The selectivity of this layer (LT/ET) is also more accentuated.

The most usual structure of the types of glazing according to the invention is shown in FIG. 3. These types of glazing comprise two glass sheets 1 and 2. These sheets can be identical or different, and may have different thicknesses or not. Sheets 1 and 2 are attached to one another by means of a thermoplastic interlayer sheet 3, a PVB sheet in the shown examples. FIG. 3 also shows a thin layer 4 which is placed on the face of one of the glass sheets on the side of the interlayer. If each of the sheets bears a functional layer, as in some of the following examples, these layers are located on either side of the interlayer.

| No | V₁ | e₁ | C | V₂ | e₂ | C | eᵥ | LT | ET | P | R | λ_{D} |
|---|---|---|---|---|---|---|---|---|---|---|---|---|
| 25 | III | 3.15 | | I | 2.1 | | 6.01 | 16.4 | 9.5 | 9.1 | 77 | 496 |
| 30 | I | 3.15 | | I | 2.1 | | 6.01 | 9.9 | 8.7 | 1.7 | 91 | 496 |
| 35 | I | 3.85 | | I | 2.1 | | 6.71 | 7.3 | 6.5 | 1.9 | 85.6 | 497 |
| 40 | I | 3.15 | | II | 2.1 | | 6.01 | 13.7 | 8.8 | 6.8 | 78 | 496 |
| 41 | I | 3.15 | | I | 2.1 | | 6.01 | 9.7 | 8.6 | 1.7 | 87.4 | 497 |
| 82 | I | 3.15 | | VI | 2.1 | | 6.01 | 12.7 | 8.1 | 9.1 | 76.2 | 493 |
| 33 | I | 3.85 | | II | 2.1 | | 6.71 | 12.3 | 8.1 | 5.1 | 81 | 498 |
| 34 | I | 3.85 | | III | 2.1 | | 6.71 | 10.2 | 6.6 | 7 | 77 | 498 |
| 54 | I | 3.85 | | IV | 2.1 | | 6.71 | 11.7 | 7.8 | 9.6 | 78.7 | 489 |
| 57 | I | 3.85 | | V | 2.1 | | 6.71 | 10.9 | 6.9 | | 77.3 | |
| 60 | I | 3.15 | | IV | 2.1 | | 6.01 | 15.7 | 10.4 | 9.4 | 80.1 | 489 |
| 63 | I | 3.15 | | V | 2.1 | | 6.01 | 14.7 | 9.2 | 9.7 | 78.7 | 489 |
| 99 | I | 3.15 | | II | 2.1 | | 6.01 | 13.9 | 9 | 6.7 | 78.9 | 496 |
| 100 | I | 3.15 | | I | 2.1 | | 6.01 | 9.3 | 8.8 | 1.7 | 87.5 | 497 |
| 105 | I | 3.15 | | IV | 2.1 | | 6.01 | 12.6 | 9 | 13.8 | 75.9 | 489 |
| 106 | I | 3.15 | | II | 2.1 | | 6.01 | 13.3 | 9.5 | 9.3 | 78.6 | 495 |
| 107 | I | 3.15 | | III | 2.1 | | 6.01 | 11.1 | 7.7 | 11.1 | 74.9 | 494 |
| 108 | I | 3.15 | | I | 2.1 | | 6.01 | 8 | 7.7 | 6.1 | 85.1 | 492 |
| 109 | I | 3.15 | | IV | 2.1 | | 6.01 | 12.6 | 9.3 | 19.4 | 72.7 | 486 |
| 110 | I | 3.15 | | II | 2.1 | | 6.01 | 13.3 | 9.8 | 14.8 | 75.5 | 489 |
| 111 | I | 3.15 | | III | 2.1 | | 6.01 | 11.6 | 8 | 16.5 | 71.9 | 489 |
| 112 | I | 3.15 | | I | 2.1 | | 6.01 | 7.9 | 8 | 12 | 82.5 | 486 |
| 113 | I | 3.15 | | IV | 2.1 | | 6.01 | 13.1 | 9.5 | 16.6 | 76.2 | 485 |
| 114 | I | 3.15 | | II | 2.1 | | 6.01 | 13.8 | 10 | 11.7 | 78.9 | 489 |
| 115 | I | 3.15 | | III | 2.1 | | 6.01 | 11.6 | 8.2 | 13.6 | 75.2 | 489 |
| 116 | I | 3.15 | | I | 2.1 | | 6.01 | 8.3 | 8 | 9.1 | 85.2 | 493 |
| 125 | II | 3.15 | | II | 2.1 | | 6.01 | 11.1 | 6.1 | 17 | 67.2 | 492 |
| 137 | I | 3.15 | | II | 2.1 | | 6.01 | 15.1 | 10.4 | 8.4 | 77.3 | 495 |
| 88 | VII | 2.1 | | VII | 2.1 | | 4.96 | 8.9 | 7.3 | 4.6 | 79.8 | 501 |
| 10 | III | 2.1 | | I | 2.1 | | 4.96 | 21.5 | 13.9 | 6.4 | | 496 |
| 15 | I | 2.1 | | I | 2.1 | | 4.96 | 15.4 | 13.6 | 1.3 | | 497 |
| 20 | III | 3.15 | | III | 2.1 | | 6.01 | 23.3 | 11.4 | 13.8 | | 494 |
| 47 | I | 2.1 | | III | 2.1 | | 4.96 | 20.8 | 13 | 6.6 | 81 | 497 |
| 48 | I | 2.1 | | I | 2.1 | | 4.96 | 14.8 | 13.1 | 1.4 | 89.8 | 497 |
| 68 | I | 2.1 | | V | 2.1 | | 4.96 | 23.8 | 14.3 | 9.4 | 80.8 | 489 |
| 71 | I | 2.1 | | IV | 3.15 | | 6.01 | 19.7 | 11.8 | 13.1 | 75.9 | 488 |
| 73 | IV | 2.1 | | III | 3.85 | | 6.71 | 22.1 | 10.7 | 17.6 | 62.6 | 493 |
| 76 | IV | 2.1 | | VI | 3.15 | | 6.01 | 23 | 11.7 | 19.5 | 62.8 | 491 |
| 83 | I | 2.1 | | VI | 2.1 | | 4.96 | 19.7 | 12.5 | 8.9 | 78.2 | 493 |
| 94 | VII | 2.1 | | V | 2.1 | | 4.96 | 17.3 | 10.6 | 10.8 | 75.7 | 492 |
| 97 | I | 3.15 | | IV | 2.1 | | 6.01 | 15.7 | 10.4 | 9.4 | 80 | 489 |
| 98 | I | 3.15 | | II | 2.1 | | 6.01 | 16.5 | 10.9 | 4.8 | 82.5 | 498 |
| 138 | I | 3.15 | | IV | 2.1 | | 6.01 | 14.8 | 11.2 | 12.4 | 76.8 | 488 |
| 140 | I | 3.15 | | II | 2.1 | | 6.01 | 16.8 | 11.3 | 5 | 81.9 | 499 |
| 141 | I | 3.15 | | IV | 2.1 | | 6.01 | 16.4 | 12.1 | 8.8 | 81.6 | 488 |
| 91 | VII | 2.1 | | III | 2.1 | | 4.96 | 16.4 | 10 | 8 | 75.9 | 498 |
| 3 | III | 2.1 | C₁ | III | 2.1 | | 4.96 | 19.9 | 10 | 15.1 | 74.8 | 488 |
| 8 | III | 2.1 | C₁ | I | 2.1 | | 4.96 | 14 | 8.3 | 10.6 | 76.7 | 491 |
| 13 | I | 2.1 | C₁ | I | 2.1 | | 4.96 | 10 | 7.8 | 5.9 | 83 | 485 |
| 18 | III | 3.15 | C₁ | III | 2.1 | | 6.01 | 15.3 | 7.3 | 17.4 | 71 | 494 |
| 23 | III | 3.15 | C₁ | I | 2.1 | | 6.01 | 10.7 | 5.8 | 13 | 75.2 | 492 |
| 28 | I | 3.15 | C₁ | I | 2.1 | | 6.01 | 6.5 | 5 | 6.2 | 84 | 486 |
| 36 | I | 3.85 | C₂ | III | 2.1 | | 6.71 | 5.8 | 3.6 | 12.8 | 73 | 489 |
| 37 | I | 3.85 | C₂ | I | 2.1 | | 6.71 | 4.2 | 3.5 | 8.4 | 82.5 | 483 |
| 44 | I | 3.15 | C₂ | III | 2.1 | | 6.01 | 7.9 | 4.9 | 12.7 | 75 | 489 |
| 45 | I | 3.15 | C₂ | I | 2.1 | | 6.01 | 5.2 | 4.7 | 8.3 | 84.1 | 482 |
| 51 | I | 2.1 | C₂ | III | 2.1 | | 4.96 | 11.9 | 7.4 | 12.5 | 77 | 489 |
| 52 | I | 2.1 | C₂ | I | 2.1 | | 4.96 | 8.7 | 7.2 | 8 | 86.4 | 482 |
| 55 | I | 3.85 | C₂ | IV | 2.1 | | 6.71 | 6.7 | 4.3 | 15.8 | 74.7 | 484 |
| 58 | I | 3.85 | C₂ | V | 2.1 | | 6.71 | 6.3 | 3.8 | 16 | 73.4 | 485 |
| 61 | I | 3.15 | C₂ | IV | 2.1 | | 6.01 | 9 | 5.8 | 15.7 | 76 | 484 |
| 64 | I | 3.15 | C₂ | V | 2.1 | | 6.01 | 8.4 | 5.1 | 15.9 | 74.6 | 485 |
| 66 | I | 2.1 | C₂ | IV | 2.1 | | 4.96 | 14 | 9 | 15.4 | 77.8 | 484 |
| 69 | I | 2.1 | C₂ | V | 2.1 | | 4.96 | 13.1 | 8 | 15.6 | 76.5 | 485 |
| 89 | VII | 2.1 | C₂ | VI | 2.1 | | 4.96 | 5.1 | 3.9 | 10.3 | 76.7 | 457 |
| 92 | VII | 2.1 | C₂ | III | 2.1 | | 4.96 | 9.4 | 5.7 | 13.6 | 72 | 467 |
| 95 | VII | 2.1 | C₂ | V | 2.1 | | 4.96 | 10 | 5.9 | 16.7 | 71.6 | 467 |
| 72 | I | 2.1 | | IV | 3.15 | C₂ | 6.01 | 11.4 | 6.7 | 19.2 | 71.7 | 485 |
| 74 | IV | 2.1 | | III | 3.85 | C₂ | 6.71 | 12.8 | 6.2 | 22.9 | 59 | 489 |
| 78 | IV | 2.1 | | VI | 3.15 | C₂ | 6.01 | 13 | 6.7 | 24.9 | 58.9 | 488 |
| 79 | IV | 2.1 | | VI | 2.1 | C₂ | 4.96 | 18 | 9.7 | 21.8 | 65.7 | 487 |
| 84 | I | 3.15 | C₂ | VI | 2.1 | | 6.01 | 7.3 | 4.5 | 15 | 72.3 | 488 |
| 85 | I | 2.1 | C₂ | VI | 2.1 | | 4.96 | 11.3 | 7 | 14.9 | 74.2 | 487 |
| 4 | III | 2.1 | C₃ | III | 2.1 | | 4.96 | 26.6 | 12 | 10.1 | | 488 |
| 9 | III | 2.1 | C₃ | I | 2.1 | | 4.96 | 18.9 | 9.5 | 5.3 | 87.1 | 502 |
| 14 | I | 2.1 | C₃ | I | 2.1 | | 4.96 | 13.5 | 8.3 | 1.9 | 88.9 | 542 |
| 19 | III | 3.15 | C₃ | III | 2.1 | | 6.01 | 20.4 | 8.9 | 12.6 | | 499 |
| 24 | III | 3.15 | C₃ | I | 2.1 | | 6.01 | 14.4 | 6.8 | 7.9 | 81 | 500 |
| 29 | I | 3.15 | C₃ | I | 2.1 | | 6.01 | 8.7 | 5.4 | 1.8 | 87.5 | 534 |
| 42 | I | 3.15 | C₃ | III | 2.1 | | 6.01 | 12.1 | 6 | 5.5 | 78 | 502 |
| 43 | I | 3.15 | C₃ | I | 2.1 | | 6.01 | 8.7 | 5.3 | 1.8 | 86 | 534 |
| 49 | I | 2.1 | C₃ | III | 2.1 | | 4.96 | 18.9 | 9.3 | 5.3 | 80 | 502 |
| 50 | I | 2.1 | C₃ | I | 2.1 | | 4.96 | 13.5 | 8.1 | 1.9 | 88.6 | 542 |
| 86 | I | 3.15 | C₃ | VI | 2.1 | | 6.01 | 11.1 | 5.5 | 7.7 | 75.5 | 496 |
| 87 | I | 2.1 | C₃ | VI | 2.1 | | 4.96 | 17.3 | 8.5 | 7.5 | 77.5 | 496 |
| 101 | I | 3.15 | C₃ | IV | 2.1 | | 6.01 | 9 | 5.8 | 15.7 | 76 | 484 |
| 102 | I | 3.15 | C₃ | II | 2.1 | | 6.01 | 9.5 | 6 | 10.8 | 78.5 | 488 |
| 103 | I | 3.15 | C₃ | III | 2.1 | | 6.01 | 8 | 5 | 12.6 | 75 | 489 |
| 104 | I | 3.15 | C₃ | I | 2.1 | | 6.01 | 5.7 | 4.8 | 8.3 | 84.2 | 482 |
| 117 | I | 3.15 | C₃ | IV | 2.1 | | 6.01 | 7.5 | 5.2 | 22.8 | 71.5 | 482 |
| 118 | I | 3.15 | C₃ | V | 2.1 | | 6.01 | 8 | 5.5 | 17.9 | 74.4 | 485 |
| 119 | I | 3.15 | C₃ | III | 2.1 | | 6.01 | 6.6 | 4.5 | 19.6 | 70.9 | 485 |
| 120 | I | 3.15 | C₃ | I | 2.1 | | 6.01 | 4.7 | 4.4 | 15.7 | 80.9 | 480 |
| 121 | I | 2.1 | C₃ | IV | 2.1 | | 4.96 | 11.7 | 8.2 | 11.6 | 73.1 | 482 |
| 122 | I | 2.1 | C₃ | II | 2.1 | | 4.96 | 12.4 | 8.6 | 17.7 | 76.1 | 485 |
| 123 | I | 2.1 | C₃ | III | 2.1 | | 4.96 | 10.4 | 7 | 19.4 | 72.5 | 485 |
| 124 | I | 2.1 | C₃ | I | 2.1 | | 4.96 | 7.4 | 6.7 | 15.5 | 83 | 480 |
| 90 | VII | 2.1 | C₃ | VII | 2.1 | | 4.96 | 7.8 | 4.4 | 3.9 | 78.7 | 481 |
| 93 | VII | 2.1 | C₃ | III | 2.1 | | 4.96 | 14.4 | 7 | 6.8 | 75.1 | 484 |
| 96 | VII | 2.1 | C₃ | V | 2.1 | | 4.96 | 15.2 | 7.3 | 9.3 | 75 | 483 |
| 80 | IV | 2.1 | | VI | 3.15 | C₃ | 6.01 | 20.3 | 8.9 | 18.1 | 62.6 | 483 |
| 81 | IV | 2.1 | C₃ | VI | 2.1 | | 4.96 | 27.6 | 12.4 | 14.7 | 69.5 | 492 |
| 1 | II | 2.1 | C₁ | III | 2.1 | C₁ | 4.96 | 13 | 6.5 | 19 | 68 | 490 |
| 6 | III | 2.1 | C₁ | I | 2.1 | C₁ | 4.96 | 9.2 | 5.2 | 14.8 | 71 | 488 |
| 11 | I | 2.1 | C₁ | I | 2.1 | C₁ | 4.96 | 6.5 | 4.7 | 10.5 | 76.2 | 483 |
| 16 | III | 3.15 | C₁ | III | 2.1 | C₁ | 6.01 | 10 | 4.8 | 21.1 | 67 | 491 |
| 21 | III | 3.15 | C₁ | I | 2.1 | C₁ | 6.01 | 7 | 3.7 | 17 | 70.5 | 489 |
| 26 | I | 3.15 | C₁ | I | 2.1 | C₁ | 6.01 | 4.2 | 3 | 10.8 | 78.1 | 483 |
| 38 | I | 3.85 | C₂ | III | 2.1 | C₂ | 6.71 | 3.4 | 2.1 | 18.9 | 69 | 491 |
| 46 | I | 3.15 | C₂ | III | 2.1 | C₂ | 6.01 | 4.5 | 2.8 | 18.8 | 70 | 485 |
| 53 | I | 2.1 | C₂ | III | 2.1 | C₂ | 4.96 | 6.9 | 4.3 | 18.6 | 72 | 485 |
| 2 | III | 2.1 | C₃ | III | 2.1 | C₁ | 4.96 | 17.4 | 7.9 | 13.8 | 74.1 | 495 |
| 7 | III | 2.1 | C₃ | I | 2.1 | C₁ | 4.96 | 12.3 | 6.2 | 9.1 | 75.3 | 494 |
| 12 | I | 2.1 | C₃ | I | 2.1 | C₁ | 4.96 | 8.8 | 5.2 | 4.3 | 81.2 | 490 |
| 17 | III | 3.15 | C₃ | III | 2.1 | C₁ | 6.01 | 13.4 | 5.9 | 16.1 | 73.8 | 495 |
| 22 | III | 3.15 | C₃ | I | 2.1 | C₁ | 6.01 | 9.4 | 4.5 | 11.6 | 76.3 | 494 |
| 27 | I | 3.15 | C₃ | I | 2.1 | C₁ | 6.01 | 5.7 | 3.4 | 4.6 | 87.3 | 491 |
| 39 | I | 3.85 | C₂ | III | 2.1 | C₃ | 6.71 | 5.1 | 2.6 | 11.3 | 73 | 491 |
| 56 | I | 3.85 | C₂ | IV | 2.1 | C₃ | 6.71 | 5.8 | 3.1 | 14.2 | 74 | 486 |
| 59 | I | 3.85 | C₂ | V | 2.1 | C₃ | 6.71 | 5.5 | 2.8 | 14.4 | 72.8 | 487 |
| 62 | I | 3.15 | C₂ | IV | 2.1 | C₃ | 6.01 | 7.9 | 4.1 | 14.1 | 75.3 | 486 |
| 65 | I | 3.15 | C₂ | IV | 2.1 | C₃ | 6.01 | 7.4 | 3.7 | 14.3 | 74 | 487 |
| 67 | I | 2.1 | C₂ | IV | 2.1 | C₃ | 4.96 | 12.3 | 6.3 | 13.8 | 77.2 | 486 |
| 164 | I | 3.15 | | I | 3.15 | | 7.06 | 5.9 | 5.8 | 5.7 | 80 | 493 |
| 165 | I | 3.15 | | I | 3.15 | | 7.06 | 6.5 | 6.2 | 2.2 | 84 | 502 |
| 166 | I | 3.15 | | I | 2.1 | | 6.01 | 9.1 | 8.8 | 5.5 | 82.6 | 492 |
| 167 | I | 3.15 | | I | 2.1 | | 6.01 | 10.1 | 9.5 | 1.9 | 87 | 501 |
| 169 | I | 3.15 | | IX | 2.1 | | 6.01 | 20 | 14 | | | |
| 170 | I | 3.15 | | II | 2.1 | | 6.01 | 16.8 | 11.3 | 5 | 81.9 | 499 |
| 171 | I | 3.15 | | VI | 2.1 | | 6.01 | 14 | 9.2 | 6.8 | 78.3 | 497 |
| 172 | I | 3.15 | | IV | 2.1 | | 6.01 | 16.4 | 12.7 | 9.8 | 80.4 | 488 |
| 173 | I | 3.15 | S | IV | 2.1 | | 6.01 | 14.4 | 8.1 | 8.3 | 79.2 | 491 |
| 174 | I | 3.15 | S | VIII | 2.1 | | 6.01 | 16.6 | 8.9 | 4.3 | 84.2 | 498 |
| 175 | I | 3.9 | | VIII | 2.1 | | 6.76 | 15.5 | 11.4 | 2.8 | 85.8 | 504 |
| 176 | I | 3.9 | S | VIII | 2.1 | | 6.76 | 12.2 | 6.6 | 4.6 | 82.4 | 498 |
| 177 | I | 3.9 | | VIII | 2.1 | | 6.76 | 14 | 10.6 | 6.3 | 81.2 | 495 |
| 178 | I | 3.9 | | IV | 2.1 | | 6.76 | 12 | 9.3 | 10 | 78.8 | 488 |
| 179 | I | 3.9 | S | IV | 2.1 | | 6.76 | 9.4 | 5.3 | 11.8 | 75.5 | 488 |

The above table illustrates that it is possible with the tested glasses to combine the most rigorous ET conditions (ET<10%) and colorimetric conditions of the invention for laminations with a thickness of less than 5 mm. In a significant number of these examples, the glazing comprises one or two sunshield layers. The most “coloured” glasses must be used to achieve the sought performance with these thicknesses without a sunshield layer.

For slightly greater thicknesses in the order of 6 mm, the performance is achieved with various combinations of glass when no sunshield layer is used.

Glasses II, III and VI are known for their solar protection properties. They do not have the light stimulus purity of the grey ones. On their own, they have a blue-green coloration on transmission with a dominant wavelength of 492 to 499 nm. When combined with grey glass, e.g. of type I, in a glazing unit, they permit a very low energy transmission to be attained while keeping the assembly within the calorimetric limits required according to the invention. In other words, the presence of grey glass allows softening of the coloration of the other sheet. The best colour renditions are of course obtained in the examples relating to the combination of two grey glasses.

Glasses IV and V have a predominantly blue wavelength (487 and 488 nm) on transmission. These glasses are used in the aim of providing a blue hue without departing from the calorimetric limits of the invention. As is the case with the previous glasses, the retention of these characteristics is by combination with a sheet of grey glass.

1-26 (Canceled).

27. Glazing with low light transmission for use in motor vehicles comprising at least two glass sheets assembled by means of a thermoplastic interlayer sheet, which has a light transmission (LT) of less than 35%, an energy transmission of less than 15% and colorimetric characteristics such that on the CIE chromaticity diagram it is included within the perimeter defined by the coordinate points: B(0.2600; 0.3450); F(0.3300; 0.3300); G(0.3150; 0.2900); H(0.2350; 0.2750).

28. Glazing according to claim 27 and further including at least one of the following (a) through (d):
a) light transmission (LT) of less than 25%;
b) energy transmission of less than 10%;
c) thickness no greater than 6.5 mm;
d) wherein at least one of the glass sheets has purity of light stimulus (P) and colour rendition index (R) characteristics which meet the following conditions:
P<20%
R>−P+80%.

29. Glazing according to claim 28 and further including at least two of the features (a) through (d).

30. Glazing according to claim 28 and further including all of the features (a) through (d).

31. Glazing according to claim 27 wherein the light transmission (LT) is less than 20%.

32. Glazing according to claim 27 wherein the light transmission (LT) is less than 10%.

33. Glazing according to claim 27 wherein the energy transmission is less than 8%.

34. Glazing according to claim 27 having a thickness no greater than 5.5 mm.

35. Glazing according to claim 27 wherein at least one of the glass sheets has a purity of light stimulus (P) and colour rendition index (R) characteristics which meet the following conditions:
P<20%
R>−P+80%, and
R is greater than 70%.

36. Glazing according to claim 27 wherein the sheets of glass and of thermoplastic material are selected such that the colour rendition index (R) of the glazing is at least equal to 70%.

37. Glazing according to claim 27 wherein the sheets of glass and of thermoplastic material are selected such that the colour rendition index (R) of the glazing is greater than 75%.

38. Glazing according to claim 27 which is included within at least one of the following perimeters on the CIE chromaticity diagram:
a) B′(0.2650; 0.3350); F′(0.3200; 0.3200); G′(0.3100; 0.3000); H′(0.2500; 0.2900);
b) B″(0.2800; 0.3300); F″(0.3089, 0.3225); G″(0.2890; 0.2975); H″(0.2600; 0.2930).

39. Glazing according to claim 27 comprising at least one glass sheet with the general composition and chromophore constituents according to one of the following (a) through (f):
(a) general composition

| | | | |
|---|---|---|---|
| SiO₂ | 60-75% | Al₂O₃ | 0-5% |
| Na₂O | 10-20% | BaO | 0-2% |
| CaO | 0-16% | BaO + CaO + MgO | 10-20% |
| K₂O | 0-10% | K₂O + Na₂O | 10-20% |
| MgO | 0-10% | | |

and comprising the following as chromophore constituents:

| | |
|---|---|
| Fe₂O₃ | 1-1.65% |
| Co | 0.017-0.030% |
| Se | 0.001-0.0100%; |

(b) general composition:

| | | | |
|---|---|---|---|
| SiO₂ | 60-75% | Al₂O₃ | 0-5% |
| Na₂O | 10-20% | BaO | 0-2% |
| CaO | 0-16% | BaO + CaO + MgO | 10-20% |
| K₂O | 0-10% | K₂O + Na₂O | 10-20% |
| MgO | 0-10% | | |

and comprising the following as chromophore constituents:

| | |
|---|---|
| Fe₂O₃ | 0.75-1.8% |
| Co | 0.0040-0.0180% |
| Se | 0.0003-0.0040% |
| Cr₂O₃ | 0.0010-0.0100%; |

(c) general composition:

| | | | |
|---|---|---|---|
| SiO₂ | 60-75% | Al₂O₃ | 0-5% |
| Na₂O | 10-20% | BaO | 0-2% |
| CaO | 0-16% | BaO + CaO + MgO | 10-20% |
| K₂O | 0-10% | K₂O + Na₂O | 10-20% |
| MgO | 0-10% | | |

and comprising the following as chromophore constituents:

| | |
|---|---|
| Fe₂O₃ (total iron) | 1.1-1.8% |
| FeO | 0.30-0.50% |
| Co | 0.0030-0.0270% |
| Cr₂O₃ | 0-0.1000% |
| V₂O₅ | 0-0.0500% |
| CeO₂ | 0-0.5% |
| TiO₂ | 0-1.5% |
| Se | 0-0.0100%; |

(d) general composition:

| | | | |
|---|---|---|---|
| SiO₂ | 60-75% | Al₂O₃ | 0-5% |
| Na₂O | 10-20% | BaO | 0-2% |
| CaO | 0-16% | BaO + CaO + MgO | 10-20% |
| K₂O | 0-10% | K₂O + Na₂O | 10-20% |
| MgO | 0-10% | | |

and comprising the following as chromophore constituents:

| | |
|---|---|
| Fe₂O₃ (total iron) | 1.2-1.85% |
| FeO | 0.40-0.50% |
| Co | 0.0020-0.013% |
| Cr₂O₃ | 0-0.1% |
| V₂O₅ | 0-0.1% |
| Se | 0-0.0015%; |

(e) general composition:

| | | | |
|---|---|---|---|
| SiO₂ | 60-75% | Al₂O₃ | 0-5% |
| Na₂O | 10-20% | BaO | 0-2% |
| CaO | 0-16% | BaO + CaO + MgO | 10-20% |
| K₂O | 0-10% | K₂O + Na₂O | 10-20% |
| MgO | 0-10% | | |

and comprising the following as chromophore constituents:

| | |
|---|---|
| Fe₂O₃ (total iron) | 1.2-1.8% |
| FeO | 0.25-0.35% |
| Co | 0.0020-0.010% |
| Cr₂O₃ | 0.001-0.0100% |
| CeO₂ | 0.1-0.8%; |

(f) general composition:

| | | | |
|---|---|---|---|
| SiO₂ | 60-75% | Al₂O₃ | 0-5% |
| Na₂O | 10-20% | BaO | 0-2% |
| CaO | 0-16% | BaO + CaO + MgO | 10-20% |
| K₂O | 0-10% | K₂O + Na₂O | 10-20% |
| MgO | 0-10% | | |

and comprising the following as chromophore constituents:

| | |
|---|---|
| Fe₂O₃ (total iron) | 0.9-1.8% |
| FeO | 0.25-0.40% |
| Co | 0.0010-0.0100% |
| Cr₂O₃ | 0-0.1% |
| V₂O₅ | 0-0.2% |

wherein % is percent by weight.

40. Glazing according to claim 27 comprising at least one sunshield layer based on a conductor oxide of the group comprising tin oxides doped with fluorine or antimony, or oxides of indium and tin.

41. Glazing according to claim 27 comprising at least one silver-based sunshield layer assembly.

42. Glazing according to claim 27 comprising a composite interlayer sheet which has a silver-based sunshield layer assembly.

43. Glazing according to claim 27 comprising a colored thermoplastic interlayer sheet.

44. Glazing according to claim 27 wherein the glass sheets are semi-toughened.

45. Glazing according to claim 27 forming part of at least one motor vehicle roof panel.

46. Glazing according to claim 27 which is within the following perimeters on the CIE chromaticity diagram:
B′(0.2650; 0.3350); F′(0.3200; 0.3200); G′(0.3100; 0.3000); H′(0.2500; 0.2900).

47. Glazing according to claim 27 comprising at least one glass sheet with the following general composition and chromophore constituents:
general composition:

| | | | |
|---|---|---|---|
| SiO₂ | 60-75% | Al₂O₃ | 0-5% |
| Na₂O | 10-20% | BaO | 0-2% |
| CaO | 0-16% | BaO + CaO + MgO | 10-20% |
| K₂O | 0-10% | K₂O + Na₂O | 10-20% |
| MgO | 0-10% | | |

chromophore constituents:

| | |
|---|---|
| Fe₂O₃ | 1-1.65% |
| Co | 0.017-0.030% |
| Se | 0.001-0.0100%; |

wherein % is percent by weight.

48. Glazing according to claim 27 comprising at least one sunshield layer based on a conductor oxide of indium and tin.

49. Glazing according to claim 27 comprising at least one glass sheet with the following general composition and chromophore constituents:
general composition:

| | | | |
|---|---|---|---|
| SiO₂ | 60-75% | Al₂O₃ | 0-5% |
| Na₂O | 10-20% | BaO | 0-2% |
| CaO | 0-16% | BaO + CaO + MgO | 10-20% |
| K₂O | 0-10% | K₂O + Na₂O | 10-20% |
| MgO | 0-10% | | |

chromophore constituents:

| | |
|---|---|
| Fe₂O₃ | 0.75-1.8% |
| Co | 0.0040-0.0180% |
| Se | 0.0003-0.0040% |
| Cr₂O₃ | 0.0010-0.0100%; |

wherein % is percent by weight.

50. Glazing according to claim 27 comprising at least one glass sheet with the following general composition and chromophore constituents:
general composition:

| | | | |
|---|---|---|---|
| SiO₂ | 60-75% | Al₂O₃ | 0-5% |
| Na₂O | 10-20% | BaO | 0-2% |
| CaO | 0-16% | BaO + CaO + MgO | 10-20% |
| K₂O | 0-10% | K₂O + Na₂O | 10-20% |
| MgO | 0-10% | | |

chromophore constituents:

| | |
|---|---|
| Fe₂O₃ (total iron) | 1.1-1.8% |
| FeO | 0.30-0.50% |
| Co | 0.0030-0.0270% |
| Cr₂O₃ | 0-0.1000% |
| V₂O₅ | 0-0.0500% |
| CeO₂ | 0-0.5% |
| TiO₂ | 0-1.5% |
| Se | 0-0.0100%; |

wherein % is percent by weight.

51. Glazing according to claim 27 comprising at least one glass sheet with the following general composition and chromophore constituents:
general composition:

| | | | |
|---|---|---|---|
| SiO₂ | 60-75% | Al₂O₃ | 0-5% |
| Na₂O | 10-20% | BaO | 0-2% |
| CaO | 0-16% | BaO + CaO + MgO | 10-20% |
| K₂O | 0-10% | K₂O + Na₂O | 10-20% |
| MgO | 0-10% | | |

chromophore constituents:

| | |
|---|---|
| Fe₂O₃ (total iron) | 1.2-1.85% |
| FeO | 0.40-0.50% |
| Co | 0.0020-0.013% |
| Cr₂O₃ | 0-0.1% |
| V₂O₅ | 0-0.1% |
| Se | 0-0.0015%; |

wherein % is percent by weight.

52. Glazing according to claim 27 comprising at least one glass sheet with the following general composition and chromophore constituents:
general composition:

| | | | |
|---|---|---|---|
| SiO₂ | 60-75% | Al₂O₃ | 0-5% |
| Na₂O | 10-20% | BaO | 0-2% |
| CaO | 0-16% | BaO + CaO + MgO | 10-20% |
| K₂O | 0-10% | K₂O + Na₂O | 10-20% |
| MgO | 0-10% | | |

chromophore constituents:

| | |
|---|---|
| Fe₂O₃ (total iron) | 1.2-1.8% |
| FeO | 0.25-0.35% |
| Co | 0.0020-0.010% |
| Cr₂O₃ | 0.001-0.0100% |
| CeO₂ | 0.1-0.8%; |

wherein % is percent by weight.

53. Glazing according to claim 27 comprising at least one glass sheet with the following general composition and chromophore constituents:
general composition:

| | | | |
|---|---|---|---|
| SiO₂ | 60-75% | Al₂O₃ | 0-5% |
| Na₂O | 10-20% | BaO | 0-2% |
| CaO | 0-16% | BaO + CaO + MgO | 10-20% |
| K₂O | 0-10% | K₂O + Na₂O | 10-20% |
| MgO | 0-10% | | |

chromophore constituents:

| | |
|---|---|
| Fe₂O₃ (total iron) | 0.9-1.8% |
| FeO | 0.25-0.40% |
| Co | 0.0010-0.0100% |
| Cr₂O₃ | 0-0.1% |
| V₂O₅ | 0-0.02%, |

wherein % is percent by weight.

54. Glazing according to claim 27 having a thickness no greater than 6.5 mm.

55. Glazing according to claim 27 having a thickness no less than 4 mm.

56. Glazing according to claim 27 having a thickness ranging from 4 mm to no greater than 6.5 mm.

57. Glazing according to claim 27 having a thickness ranging from 4 mm to no greater than 5.5 mm.
